(19) United States
(12) Patent Application Publication
(10) Pub. No.: US 2022/0388399 A1
(43) Pub. Date: Dec. 8, 2022

(54) VEHICLE STATE DISPLAY DEVICE AND VEHICLE STATE DISPLAY METHOD

(71) Applicant: MITSUBISHI JIDOSHA KOGYO KABUSHIKI KAISHA, Tokyo (JP)

(72) Inventors: Yuichi TOMIDA, Tokyo (JP); Makoto KAMIHIRA, Tokyo (JP); Akihiro SHIINO, Tokyo (JP); Masako ABE, Tokyo (JP)

(73) Assignee: MITSUBISHI JIDOSHA KOGYO KABUSHIKI KAISHA, Tokyo (JP)

(21) Appl. No.: 17/642,859

(22) PCT Filed: Apr. 21, 2021
(86) PCT No.: PCT/JP2021/016231

§ 371 Date: Mar. 14, 2022

(30) Foreign Application Priority Data
Apr. 28, 2020 (JP) 2020-078922

(51) Int. Cl. B60L 3/00; B60K 35/00; B60L 58/12

(52) U.S. Cl. CPC B60L 3/0046; B60K 35/00; B60L 58/12; B60L 2240/545

(57) ABSTRACT

A vehicle state display device for a vehicle includes an output limiting unit that limits an output of the vehicle when charge of a battery is equal to or smaller than a first value and a battery state display unit that displays a state of the battery. The battery state display unit switches and displays a first display mode indicating that the state of charge of the battery exceeds a second value that is larger than the first value, a second display mode indicating that the state of charge of the battery is equal to or smaller than the second value and exceeds the first value and the output of the vehicle may be limited, and a third display mode indicating that the state of charge of the battery is equal to or smaller than the first value and the output of the vehicle is being limited.

### TECHNICAL FIELD

The present disclosure relates to a vehicle state display device and a vehicle state display method for displaying a state of a vehicle.

### BACKGROUND ART

In related-art, in an electric vehicle that travels using electric power as at least a part of power, there is known a technique of limiting an output of the vehicle when a state of charge of a battery that stores the electric power is low, and notifying a user that the output is limited.

For example, Patent Literature 1 below discloses an electric vehicle that includes a battery, a traveling motor, an inverter, and a warning display device, and travels by driving the traveling motor with electric power of the battery, the electric vehicle including: a control unit that limits electric power required for the traveling motor or electric power output from the battery, and switches a display of the warning display device. The control unit includes: a required electric power limiting unit that limits the electric power required for the traveling motor when a state of charge (SOC) of the battery is smaller than a predetermined capacity; an output voltage limiting unit that limits the electric power output from the battery according to an output characteristic of the battery when the state of charge (SOC) of the battery exceeds a predetermined capacity; and a warning display unit that displays a limiting state on the warning display device when the electric power required for the traveling motor is limited or an output of the battery is limited.

### CITATION LIST

### Patent Literature

Patent Document 1: JP-B-5730588

### SUMMARY OF INVENTION

### Technical Problem

When output limitation of a vehicle is started, a driving feeling is greatly different from a normal driving feeling, for example, normal acceleration cannot be performed even if an accelerator pedal is depressed. In the related art described above, when the state of charge of the battery is smaller than a threshold value, output limitation of the vehicle is suddenly started, and thus a user may be confused. In addition, in the related art, since the output limitation is started without pre-notification, there is a problem that it is difficult for the user to perform a driving operation for avoiding the output limitation.

The present disclosure has been made in view of such circumstances, and an object thereof is to reduce inconvenience associated with output limitation of a vehicle.

### Solution to Problem

In order to achieve the above object, a vehicle state display device according to the present disclosure is a vehicle state display device for a vehicle including a driving motor configured to drive a drive wheel of the vehicle and a battery configured to store electric power used by the driving motor, the vehicle state display device including: an output limiting unit configured to limit an output of the vehicle in a case that a state of charge of the battery is equal to or smaller than a first value; and a battery state display unit configured to display a state of the battery on a display. The battery state display unit switches and displays a first display mode indicating that the state of charge of the battery exceeds a second value that is larger than the first value, a second display mode indicating that the state of charge of the battery is equal to or smaller than the second value and exceeds the first value and the output of the vehicle may be limited, and a third display mode indicating that the state of charge of the battery is equal to or smaller than the first value and the output of the vehicle is being limited.

A vehicle state display method according to the present disclosure is a vehicle state display method for displaying a vehicle state of a vehicle including a driving motor configured to drive a drive wheel of the vehicle and a battery configured to store electric power used by the driving motor, the vehicle state display method including: a step of limiting an output of the vehicle in a case that a state of charge of the battery is equal to or smaller than a first value; and a step of displaying a state of the battery on a display. The displaying step switches and displays a first display mode indicating that the state of charge of the battery exceeds a second value that is larger than the first value, a second display mode indicating that the state of charge of the battery is equal to or smaller than the second value and exceeds the first value and the output of the vehicle may be limited, and a third display mode indicating that the state of charge of the battery is equal to or smaller than the first value and the output of the vehicle is being limited.

### Advantageous Effects of Invention

According to the present disclosure, since a pre-notification display (display in second display mode) is performed before output limitation associated with a decrease in the state of charge of the battery is started, it is possible to notify a user that the output may be limited, which is advantageous in improving convenience of the user. In addition, since the user who views the pre-notification display can actively perform a driving operation for avoiding the output limitation, a frequency of performing the output limitation can be reduced, which is advantageous in preventing deterioration of the battery.

### BRIEF DESCRIPTION OF DRAWINGS

FIG. 1 is a diagram showing a configuration of a vehicle on which a vehicle state display device according to an embodiment is mounted.

FIG. 2 is a view showing an example of an installation mode of a display.

FIG. 3(A) to (G) of FIG. 3 are views showing examples of a display by a battery state display unit.

FIG. 4 is a diagram showing a relationship between a content displayed by the battery state display unit and a state of charge of the battery.

FIG. 5 is a flowchart showing a procedure of processing executed by the vehicle state display device.

### DESCRIPTION OF EMBODIMENTS

Hereinafter, a preferred embodiment of a vehicle state display device according to the present disclosure will be described in detail with reference to the accompanying drawings.

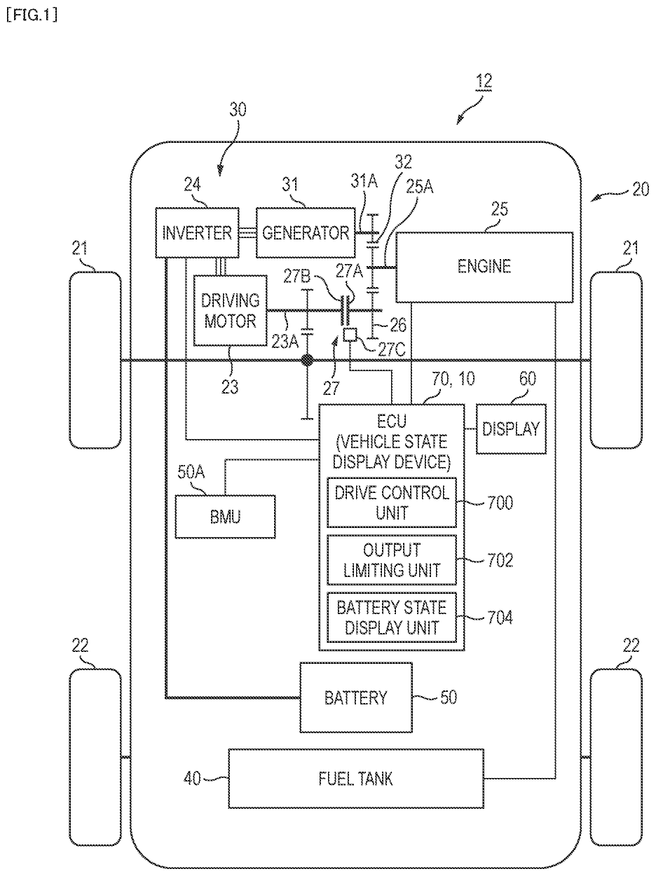

FIG. 1 is a diagram showing a configuration of a vehicle on which a vehicle state display device according to an embodiment is mounted.

A vehicle 12 is an electric vehicle including at least a driving motor that drives drive wheels and a battery that accumulates electric power used by the driving motor. In the present embodiment, a hybrid vehicle including an engine and a motor will be described as an example of the vehicle (electric vehicle) on which the vehicle state display device is mounted.

The vehicle on which the vehicle state display device is mounted is not limited to the hybrid vehicle, and may be an electric vehicle including only a battery and a motor. In the present embodiment, a gasoline engine using gasoline as fuel is described as an example of the engine mounted on the vehicle, but the vehicle may be a diesel hybrid vehicle using a diesel engine using light oil as fuel.

As shown in FIG. 1, the vehicle 12 includes a traveling system 20, a power generation system 30, and an ECU 70.

The traveling system 20 is a drive mechanism of the vehicle 12, and includes front wheels 21 and rear wheels 22, a driving motor 23, an inverter 24, an engine 25, a transmission mechanism 26 that transmits rotation of an output shaft 23A of the driving motor 23 and rotation of an output shaft 25A of the engine 25 to the front wheels 21, a fuel tank 40, and a battery 50.

The front wheels 21 and the rear wheels 22 each includes two wheels that are paired in a vehicle width direction. In the present embodiment, the front wheels 21 are drive wheels of the driving motor 23 and the engine 25. For example, the driving motors 23 (a front wheel driving motor and a rear wheel driving motor) may be respectively provided for the front wheels 21 and the rear wheels 22.

The driving motor 23 is driven by using electric power stored in the battery 50, and outputs a rotational force (torque) from the output shaft 23A. The driving motor 23 can also perform regenerative operation to generate regenerative power when the vehicle 12 is decelerated (such as when an accelerator pedal is released). The electric power generated by regenerative power generation is supplied to the battery 50 via the inverter 24 to charge the battery 50.

The inverter 24 adjusts the electric power of the battery 50 based on a request from a user (driver) and supplies the adjusted electric power to the driving motor 23. The request from the user is, for example, an operation of an accelerator pedal, a brake pedal, a shift lever (not shown), or the like, a vehicle speed measured by a vehicle speed sensor, or the like, and is calculated by the ECU 70 to be described later. The ECU 70 controls the inverter 24 based on the calculated output value of the request from the user.

The engine 25 is driven by burning fuel supplied from the fuel tank 40 in a combustion chamber. In the present embodiment, the engine 25 is a reciprocating engine using gasoline as the fuel. The engine 25 is driven under control of the ECU 70 to be described later.

The transmission mechanism 26 transmits the rotation of the output shaft 23A of the driving motor 23 to the front wheels 21, and transmits the rotation of the output shaft 25A of the engine 25 to the front wheels 21. The transmission mechanism 26 includes a clutch device 27. The clutch device 27 includes a drive unit 27C that allows a pair of clutch plates 27A, 27B to come into contact with each other and releases a contact state.

The clutch plate 27A rotates integrally with the output shaft 25A of the engine 25. The clutch plate 27B rotates integrally with the output shaft 23A of the driving motor 23. When the clutch plates 27A, 27B are brought into contact with each other by the drive unit 27C, the clutch plates 27A, 27B rotate integrally with each other. Thereby, the rotation of the output shaft 25A of the engine 25 is transmitted to the front wheels 21. When the clutch plates 27A, 27B are separated from each other by the drive unit 27C, the rotation of the output shaft 25A of the engine 25 is not transmitted to the front wheels 21. The drive unit 27C is controlled by the ECU 70 to be described later.

The fuel tank 40 stores the fuel (gasoline in the present embodiment) that is a power source of the engine 25.

The battery 50 stores the electric power that is a power source of the driving motor 23. The battery 50 can be charged by power generation by a generator 31 to be described later, regenerative power generation by the driving motor 23, electric power supply from an external power source via a charging connector (not shown) provided on a vehicle body of the vehicle 12, and the like.

A battery management unit (BMU) 50A is connected to the battery 50. The BMU 50A detects a voltage and a temperature of the battery 50, an input/output current, and the like, and detects a state of the battery 50 including a state of charge (SOC). The BMU 50A transmits the state of the battery 50 (a state of charge, a battery voltage, a battery temperature, and the like) to the ECU 70.

The power generation system 30 is a mechanism for charging the battery 50, and includes the engine 25, the generator 31, and the inverter 24.

The rotation of the output shaft 25A of the engine 25 is transmitted to a rotation shaft 31A of the generator 31 via a second transmission mechanism 32. When the generator 31 is brought into a state capable of generating electric power under control of the ECU 70, the rotation shaft 31A rotates in response to the rotation of the output shaft 25A of the engine 25, and the generator 31 generates the electric power. The generator 31 is connected to the inverter 24, and AC power generated by the generator 31 is converted into DC power by the inverter 24, and the battery 50 is charged with the DC power.

In a series traveling mode to be described later, the AC power generated by the generator 31 is used to drive the driving motor 23 directly. In this case, the electric power generated by the generator 31 is supplied to the driving motor 23 after a frequency of the electric power is appropriately converted by the inverter 24.

The generator 31 also functions as an electric motor (starter) at the time of starting the engine 25. When the engine 25 is started, the ECU 70 controls the inverter 24 to drive the generator 31. When the generator 31 is driven, the rotation shaft 31A rotates. Since the rotation shaft 31A is connected to the output shaft 25A of the engine 25 via the second transmission mechanism 32, the output shaft 25A of the engine 25 can be rotated when the generator 31 is driven to rotate the rotation shaft 31A.

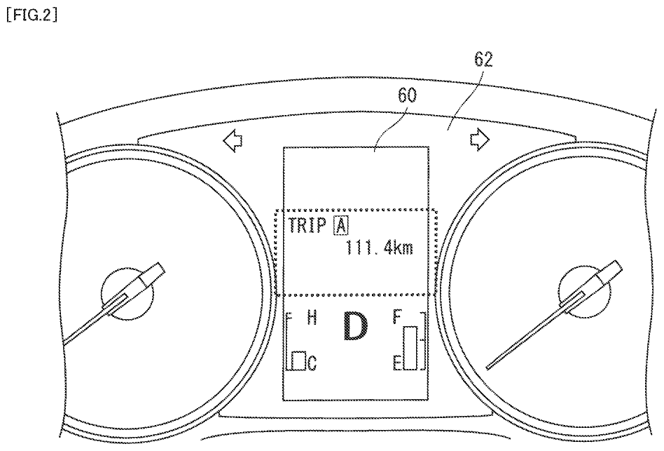

A display 60 is provided at a position visible to the user who is driving in a vehicle, and displays various types of information. For example, as shown in FIG. 2, the display 60 is provided in an instrument panel 62 of the vehicle 12. A battery state display unit 704 to be described later displays a battery state using a partial area of the display 60 (within a dotted line frame in FIG. 2).

The display 60 may use a windshield of the vehicle, for example, a head-up display. A display content of the display 60 is controlled by the battery state display unit 704 of the ECU 70 to be described later.

The ECU 70 functions as a vehicle control device that controls the entire vehicle 12, and also functions as a vehicle state display device 10 that displays a state of the vehicle 12 on the display 60.

The ECU 70 includes a CPU, a ROM that stores and memorizes a control program and the like, a RAM as an operation area of the control program, an EEPROM that rewritably holds various types of data, an interface unit that interfaces with a peripheral circuit and the like, and the like.

The ECU 70 realizes a drive control unit 700, an output limiting unit 702, and a battery state display unit 704 by the CPU executing the control program.

The drive control unit 700 controls each unit of the vehicle 12, for example, the driving motor 23, the engine 25, the generator 31, the drive unit 27C of the clutch device 27, and the like, based on setting from the user, a state of charge of the battery 50, and the like input via various operation units (not shown).

The drive control unit 700 drives the vehicle 12 by appropriately switching among three traveling modes of the vehicle 12, that is, A. an electric vehicle (EV) traveling mode, B. a series traveling mode, and C. a parallel traveling mode.

Hereinafter, the three traveling modes will be described.

### A. EV Traveling Mode

This is a mode in which the engine 25 is stopped, and the vehicle travels by rotating an axle by a driving force of the driving motor 23. Electric power supplied to the driving motor 23 in the EV traveling mode is only the stored electric power stored in the battery 50.

### B. Series Traveling Mode

This is a mode in which the vehicle travels by rotating the axle by a driving force of the driving motor 23 while generating electric power by driving the generator 31 by the engine 25. Electric power supplied to the driving motor 23 in the series traveling mode is the stored electric power stored in the battery 50 and the generated electric power generated by the generator 31.

For example, when the state of charge of the battery 50 decreases to or below a predetermined value (hereinafter, referred to as a “power generation start state of charge”) during the EV traveling mode, the traveling mode is switched to the series traveling mode. That is, when the state of charge of the battery 50 is equal to or smaller than the power generation start state of charge, the generator 31 performs the forced power generation. Also, when required output is equal to or larger than a predetermined value at low to medium speeds (for example, when an accelerator is depressed) in the EV traveling mode, the traveling mode is switched to the series mode in order to supply the electric power generated by the generator 31 to the driving motor 23 in addition to the electric power from the battery 50.

### C. Parallel Traveling Mode

This is a mode in which the vehicle travels by rotating the axle by a driving force of the engine 25 and a driving force of the driving motor 23. In particular, when an efficiency of axle driving by the engine 25 is high, such as when the vehicle is traveling at a high speed, the traveling mode is switched to the parallel traveling mode. The axle is mainly driven the engine 25, and the driving motor 23 assists at the time of acceleration or the like. Even in the parallel traveling mode, the driving force of the engine 25 can be transmitted to the generator 31 to generate electric power (that is, the driving force of the engine 25 can be distributed between traveling and power generation).

The output limiting unit 702 limits an output of the vehicle 12 when the state of charge of the battery 50 is equal to or smaller than a first value. For example, in a high load state in which the vehicle travels on a slope having a steep gradient, when the output required for traveling of the vehicle exceeds the maximum output of the engine 25, the output required for traveling cannot be covered only by the engine 25, and thus the output is supplemented by the battery 50. That is, the battery 50 is discharged. When such a high load state is continued, the state of charge of the battery 50 decreases, and over-discharge, which may be a cause of deterioration of the battery 50, may finally occur. The output limiting unit 702 limits the output of the vehicle in order to prevent such over-discharge.

Hereinafter, in the present embodiment, the “first value” of the state of charge is referred to as an “output limiting state of charge”. In the present embodiment, it is assumed as: output limiting state of charge < power generation start state of charge.

The battery state display unit 704 displays the state of the battery 50 on the display 60. In the present embodiment, the battery state display unit 704 mainly displays whether the vehicle 12 is in an output limiting state, and a grace of the state of charge until output limitation is started.

That is, the battery state display unit 704 switches and displays a first display mode indicating that the state of charge of the battery 50 exceeds a second value that is larger than the first value (output limiting state of charge), a second display mode indicating that the state of charge of the battery 50 is equal to or smaller than the second state of charge and exceeds the first state of charge and the output of the vehicle 12 may be limited (a grace until the output of the vehicle is limited), and a third display mode indicating that the state of charge of the battery 50 is equal to or smaller than the first state of charge and the output of the vehicle 12 is being limited.

Hereinafter, in the present embodiment, the “second value” of the state of charge is referred to as a “pre-notification start state of charge”.

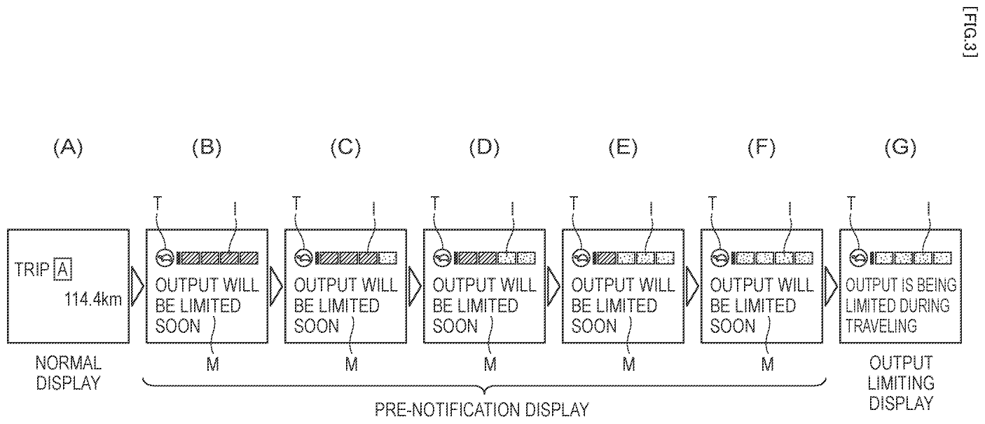

(A) to (G) of FIG. 3 are views showing examples of a display by the battery state display unit.

The pre-notification start state of charge that is a value larger than the output limiting state of charge is set in advance with respect to the state of charge of the battery 50 (pre-notification start state of charge > output limiting state of charge). While the state of charge of the battery 50 exceeds the pre-notification start state of charge (current state of charge > pre-notification start state of charge), a normal display (first display mode) shown in (A) of FIG. 3 is displayed on the display 60. In the present embodiment, it is assumed that the normal display displays a continuous traveling distance of the vehicle 12.

When the state of charge of the battery 50 is equal to or smaller than the pre-notification start state of charge (current state of charge <pre-notification start state of charge), the battery state display unit 704 displays a pre-notification display (second display mode) shown in (B) of FIG. 3 to (F) of FIG. 3 on the display 60 (switches the normal display to the pre-notification display).

The pre-notification display includes a message display M (“Output limitation will be started soon”) for notifying that the output limitation may be started, and an indicator display I indicating a grace of the state of charge until the output limitation is started. A turtle mark at a left end is an output limiting display T indicating whether the output is limited, and is displayed so as to be less noticeable than the pre-notification display, for example, in an achromatic color during the pre-notification display (when the output is not limited).

In the examples in FIG. 3, the indicator display I is divided into four areas, and each region is displayed in a chromatic color or an achromatic color. The larger the number of areas displayed in the chromatic color, the larger the grace of the state of charge (remaining amount of electric power) until the output limitation is started, and the smaller the number of areas displayed in the chromatic color, the smaller the grace of the state of charge until the output limitation is started.

That is, the second display mode includes the indicator display I indicating a difference between the current state of charge of the battery 50 and the first value (output limiting state of charge).

Instead of dividing the indicator display I into a plurality of areas as in the present embodiment, the indicator display I may have a display mode in which a length of a bar graph continuously changes, for example. The number of divisions of the indicator display is not limited to four, and may be any number of two or larger.

For example, in (B) of FIG. 3, all of the four areas are displayed in the chromatic color, and this indicates that the grace until the output limitation is started is relatively large. When the vehicle 12 continues to travel in the same state (traveling speed, pitching, presence or absence of towing, and the like), the state of charge of the battery 50 decreases, and the display is switched in an order of (C) of FIG. 3 (chromatic color 3, achromatic color 1), (D) of FIG. 3 (chromatic color 2, achromatic color 2), (E) of FIG. 3 (chromatic color 1, achromatic color 3), and (F) of FIG. 3 (chromatic color 0, achromatic color 4). At this time, chromatic color areas are decreased in order from a chromatic color area far from the output limiting display T (the chromatic color area is switched to an achromatic color area). As a result, it is possible to visually express that the grace until the output limitation is started gradually decreases.

In the present embodiment, for example, a background color of the display 60 is black, blue is adopted as the chromatic color of the indicator display I, and gray is adopted as the achromatic color. In addition, the output limiting display T during pre-notification display is white.

When the state of charge of the battery 50 is restored by taking measures such as deceleration or stop of the vehicle 12 by the user during the pre-notification display, the battery state display unit 704 increases the chromatic color area of the indicator display I, and returns to the normal display when the state of charge of the battery 50 exceeds the pre-notification start state of charge.

That is, when the state of charge of the battery 50 exceeds the second value (pre-notification start state of charge) after the display of the second display mode is started, the battery state display unit 704 switches the display to the first display mode.

Then, when the state of charge of the battery 50 is smaller than the output limiting state of charge, the output limitation by the output limiting unit 702 is started, and the battery state display unit 704 displays an output limiting display (third display mode) shown in (G) of FIG. 3.

The output limiting display T while the output is being limited is switched from white, which is a display color during the pre-notification display, to a chromatic color, for example, orange.

That is, the second display mode and the third display mode include the output limiting display T indicating whether the output is limited, and the output limiting display T in the third display mode is displayed in a color tone having a saturation higher than that of the output limiting display T in the second display mode.

This makes it possible to visually indicate that the output limitation has been started.

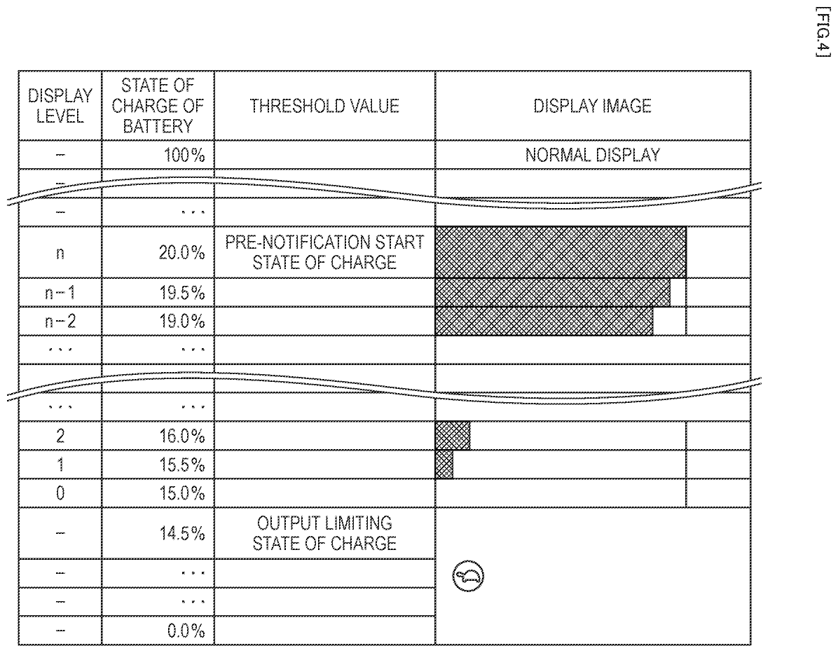

FIG. 4 is a diagram showing a relationship between a content displayed by the battery state display unit and the state of charge of the battery.

In an example in FIG. 4, the output limiting state of charge is 14.5%, and the pre-notification start state of charge is 20.0%. Since the indicator display I of the pre-notification display is switched in increments of 0.5% of the state of charge, the display is switched more finely than in the examples in FIG. 3.

When the state of charge of the battery 50 exceeds 20.0%, which is the pre-notification start state of charge, the battery state display unit 704 displays the normal display illustrated in (A) of FIG. 3 on the display 60.

When the state of charge of the battery 50 is 20.0% or smaller, the battery state display unit 704 changes the display of the display 60 to the pre-notification display. In the example in FIG. 4, the indicator display I is divided into n areas in increments of 0.5% of the state of charge, and the number of chromatic color display areas changes each time the state of charge changes by 0.5%.

When the state of charge of the battery 50 is equal to or smaller than 14.5%, which is an output start state of charge, the battery state display unit 704 changes the display of the display 60 to the output limiting display illustrated in (G) of FIG. 3.

The output limiting unit 702 may limit the output based on a temperature of the battery 50 (battery temperature). Specifically, the output limiting unit 702 limits the output of the vehicle 12 when the temperature of the battery 50 exceeds a predetermined output limiting temperature. This is because, when the temperature of the battery 50 is high, output performance of the battery 50 decreases and the driving force is insufficient. When the battery 50 is used in a high-temperature state for a long time, the battery 50 itself or peripheral components thereof may fail.

When the output is limited due to the battery temperature, the battery state display unit 704 displays the output limiting display (third display mode) regardless of the state of charge of the battery 50.

In order to prevent an excessive load on the battery 50, for example, the output limiting state of charge or the pre-notification start state of charge may be changed based on the battery temperature. Specifically, for example, when the battery temperature is equal to or higher than a predetermined temperature, the output limiting state of charge or the pre-notification start state of charge may be increased in proportion to the battery temperature, and the output limitation or the pre-notification display may be started at an earlier timing.

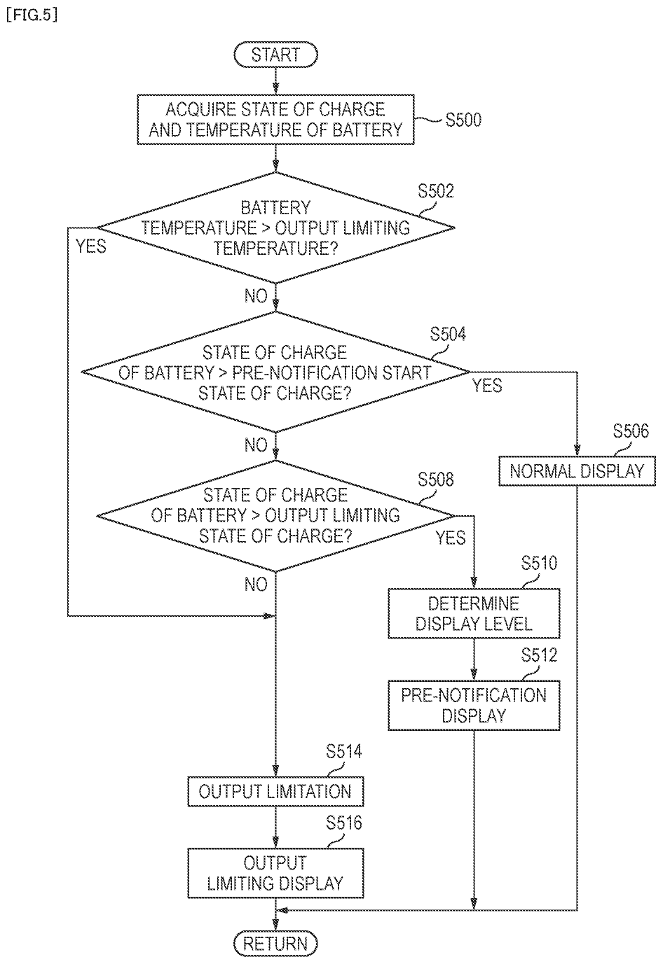

FIG. 5 is a flowchart showing a procedure of processing executed by the vehicle state display device.

The output limiting unit 702 acquires information on a state of charge and a temperature of the battery 50 from the BMU 50A (step S500).

When the temperature of the battery 50 exceeds an output limiting temperature (step S502: Yes), the output limiting unit 702 limits an output of the battery 50 regardless of the state of charge of the battery 50 (step S514), and the battery state display unit 704 displays an output limiting display on the display 60 (step S516).

On the other hand, when the temperature of the battery 50 does not exceed the output limiting temperature (step S502: No), the battery state display unit 704 determines whether the state of charge of the battery 50 exceeds a pre-notification start state of charge (step S504).

When the state of charge of the battery 50 exceeds the pre-notification start state of charge (step S504: Yes), the battery state display unit 704 displays a normal display on the display 60 (step S506).

When the state of charge of the battery 50 does not exceed the pre-notification start state of charge, that is, is equal to or smaller than the pre-notification start state of charge (step

S504: No), the battery state display unit 704 determines whether the state of charge of the battery 50 exceeds an output limiting state of charge (step S508).

When the state of charge of the battery 50 exceeds the output limiting state of charge (step S508: Yes), the battery state display unit 704 determines that a display level of a pre-notification display is the indicator display I based on the state of charge (step S510), and displays the pre-notification display on the display 60 (step S512).

When the state of charge of the battery 50 does not exceed the output limiting state of charge, that is, is equal to or smaller than the output limiting state of charge (step S508: No), the output limiting unit 702 limits the output of the battery 50 (step S514), and the battery state display unit 704 displays the output limiting display on the display 60 (step S516).

As described above, according to the vehicle state display device 10 according to the embodiment, since the pre-notification display is performed before the output limitation associated with a decrease in the state of charge of the battery 50 is started, it is possible to notify the user that the output may be limited, which is advantageous in improving convenience of the user. In addition, since the user who views the pre-notification display can actively perform a driving operation for avoiding the output limitation, a frequency of performing the output limitation can be reduced, which is advantageous in preventing deterioration of the vehicle 12.

In the vehicle state display device 10, if the indicator display I indicating the difference between the current state of charge of the battery 50 and the output limiting state of charge is included in the pre-notification display, the user can intuitively grasp the grace until the output is limited, which is advantageous in further improving the convenience of the user.

In the vehicle state display device 10, when the output is limited based on the temperature of the battery 50, it is possible to more reliably prevent the deterioration of the battery 50 due to an excessive load.

The present application is based on Japanese Patent Application No. 2020-078922 filed on Apr. 28, 2020, the contents of which are incorporated herein as reference.

### INDUSTRIAL APPLICABILITY

According to a vehicle state display device and a vehicle state display method according to the present disclosure, it is possible to reduce inconvenience associated with output limitation of a vehicle.

### REFERENCE SIGNS LIST

10 vehicle state display device

12 vehicle

20 traveling system

23 driving motor

25 engine

30 power generation system

31 generator

40 fuel tank

50 battery

60 display

70 ECU

700 drive control unit

702 output limiting unit

704 battery state display unit

1. A vehicle state display device for a vehicle including a driving motor configured to drive a drive wheel of the vehicle and a battery configured to store electric power used by the driving motor, the vehicle state display device comprising:
an output limiting unit configured to limit an output of the vehicle in a case that a state of charge of the battery is equal to or smaller than a first value; and
a battery state display unit configured to display a state of the battery on a display,
wherein the battery state display unit switches and displays a first display mode indicating that the state of charge of the battery exceeds a second value that is larger than the first value, a second display mode indicating that the state of charge of the battery is equal to or smaller than the second value and exceeds the first value and the output of the vehicle may be limited, and a third display mode indicating that the state of charge of the battery is equal to or smaller than the first value and the output of the vehicle is being limited.

2. The vehicle state display device according to claim 1,
wherein the second display mode includes an indicator display indicating a difference between a current state of charge of the battery and the first value.

3. The vehicle state display device according to claim 1,
wherein the battery state display unit switches a display from the second display mode to the first display mode in a case that the state of charge of the battery exceeds the second value after the display of the second display mode is started.

4. The vehicle state display device according to claim 1,
wherein the output limiting unit limits the output of the vehicle in a case that a temperature of the battery exceeds an output limiting temperature, and
wherein the battery state display unit displays the third display mode regardless of the state of charge of the battery.

5. The vehicle state display device according to claim 1,
wherein the second display mode and the third display mode include an output limiting display indicating whether the output is limited, and
wherein the output limiting display in the third display mode is displayed in a color tone having a saturation higher than that of the output limiting display in the second display mode.

6. A vehicle state display method for displaying a vehicle state of a vehicle including a driving motor configured to drive a drive wheel of the vehicle and a battery configured to store electric power used by the driving motor, the vehicle state display method comprising:
a step of limiting an output of the vehicle in a case that a state of charge of the battery is equal to or smaller than a first value; and
a step of displaying a state of the battery on a display,
wherein the displaying step switches and displays a first display mode indicating that the state of charge of the battery exceeds a second value that is larger than the first value, a second display mode indicating that the state of charge of the battery is equal to or smaller than the second value and exceeds the first value and the output of the vehicle may be limited, and a third display mode indicating that the state of charge of the battery is equal to or smaller than the first value and the output of the vehicle is being limited.
